(19) United States
(12) Patent Application Publication
(10) Pub. No.: US 2016/0142300 A1
(43) Pub. Date: May 19, 2016

(54) TRANSMISSION SYSTEM, TRANSMISSION DEVICE, AND TRANSMISSION METHOD

(71) Applicant: FUJITSU LIMITED, Kawasaki-shi (JP)

(72) Inventors: Hirofumi Araki, Kawasaki (JP); Hiroshi Oikawa, Yokohama (JP); Yoshitaka TAKI, Kawasaki (JP); SATORU MIYAZAKI, Setagaya (JP)

(73) Assignee: FUJITSU LIMITED, Kawasaki-shi (JP)

(21) Appl. No.: 14/926,047

(22) Filed: Oct. 29, 2015

(30) Foreign Application Priority Data
Nov. 18, 2014 (JP) 2014-233869

(51) Int. Cl. H04L 12/723; H04J 3/16

(52) U.S. Cl. CPC H04L 45/50; H04J 3/1652

(57) ABSTRACT

A transmission system includes: a first transmission device configured to transmit an input signal to a second transmission device via a transmission section, the first transmission device preforms operations of: saving overhead information included in a first frame of the input signal from a region in use to an unused region of the first frame, the overhead information corresponding to an object of termination in the transmission section; and transmitting, to the transmission section, a first signal including a second frame in which the overhead information is saved.

### CROSS-REFERENCE TO RELATED APPLICATION

This application is based upon and claims the benefit of priority of the prior Japanese Patent Application No. 2014-233869, filed on Nov. 18, 2014, the entire contents of which are incorporated herein by reference.

### FIELD

The embodiments discussed herein are related to a transmission system, a transmission device, and a transmission method.

### BACKGROUND

In an optical transport network (OTN) transmission system illustrated in an international telecommunication union (ITU)-T G.709 standard, a client signal flowing into an optical network is transmitted as an optical channel transport unit (OTU). The OTU stores a payload storing the client signal as well as overhead (OH) information of an optical channel payload unit (OPU) and OH information of an optical channel data unit (ODU).

A related technology is disclosed in Japanese Laid-open Patent Publication No. 2004-266480.

### SUMMARY

According to an aspect of the embodiments, a transmission system includes: a first transmission device configured to transmit an input signal to a second transmission device via a transmission section, the first transmission device preforms operations of: saving overhead information included in a first frame of the input signal from a region in use to an unused region of the first frame, the overhead information corresponding to an object of termination in the transmission section; and transmitting, to the transmission section, a first signal including a second frame in which the overhead information is saved.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of OTN transmission;

FIG. 2 illustrates an example of OTN transmission;

FIG. 3 illustrates an example of a transmission system;

FIG. 4 illustrates an example of hardware configuration of a transmission system;

FIG. 5A illustrates an example of processing on a transmitting side;

FIG. 5B illustrates an example of processing on a receiving side;

FIG. 6 illustrates an example of overhead information;

FIG. 7 illustrates an example of overhead information;

FIG. 8 illustrates an example of an OTU4 frame;

FIG. 9 illustrates an example of frames as saving destinations;

FIG. 10 illustrates an example of a transmission system;

FIG. 11A illustrates an example of processing on a transmitting side;

FIG. 11B illustrates an example of processing on a receiving side;

FIG. 12 illustrates an example of processing of a transmission system;

FIG. 13A illustrates an example of processing on a master (transmitting) side; and

FIG. 13B illustrates an example of processing on a slave (receiving) side.

### DESCRIPTION OF EMBODIMENTS

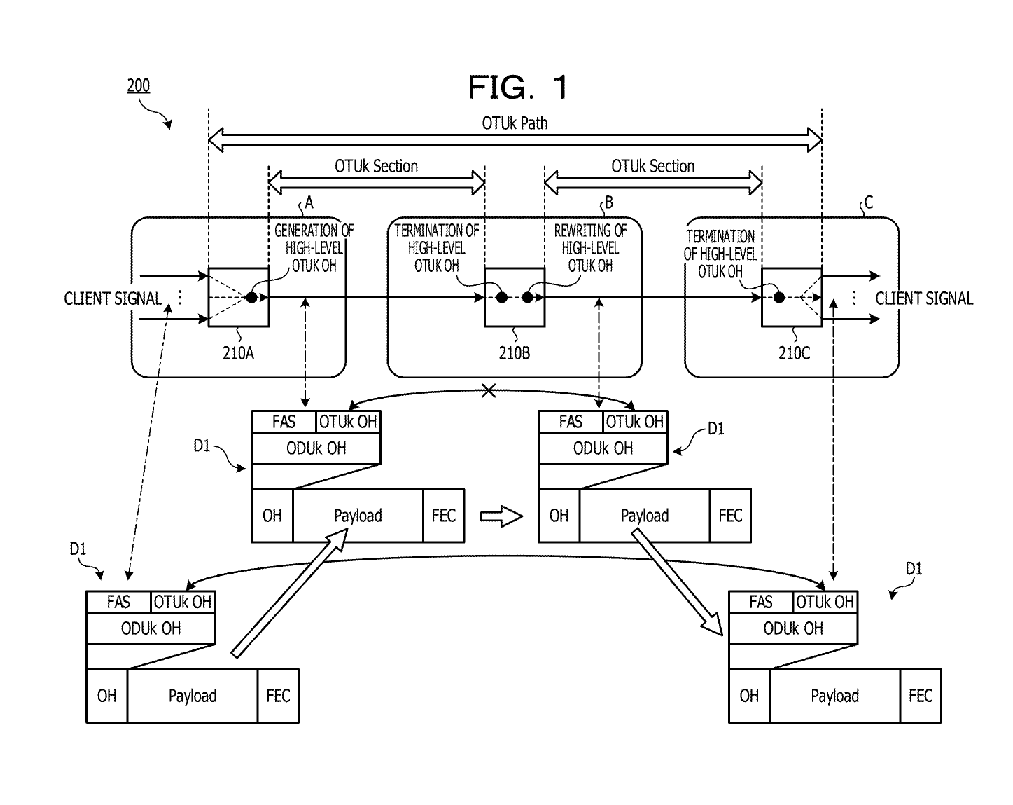

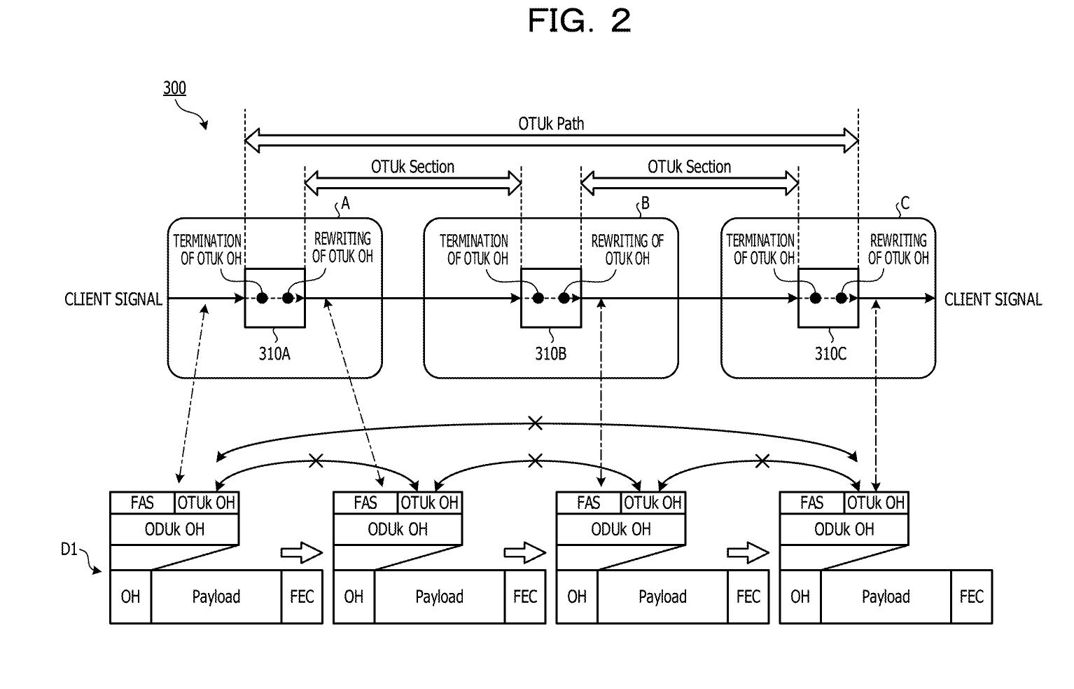

In OTN transmission, OH information in a client signal may not be transmitted transparently in a given transmission section. FIG. 1 and FIG. 2 illustrate an example of OTN transmission. In transmission systems 200 and 300 illustrated in FIG. 1 and FIG. 2, a client signal D1 is input from network equipment A, passed through network equipment B, and then output from network equipment C.

As illustrated in FIG. 1, the client signal D1 in the transmission system 200 may be a synchronous digital hierarchy (SDH)/Ethernet (registered trademark) signal or an OTUk signal in a low-level (lower) layer. In an OTUk section of the pieces of network equipment A and B and an OTUk section of the pieces of network equipment B and C in an ODUk path between the pieces of network equipment A and C, OTUk OH information is terminated.

The client signal D1 input to a transmission device 210A of the network equipment A is mapped into a payload of an OTUk signal in a high-level (upper) layer, and is then transmitted to a transmission device 210B of the network equipment B. The client signal D1 is transmitted through the transmission device 210B to a transmission device 210C of the network equipment C, extracted by the transmission device 210C from the payload of the OTUk signal in the high-level (upper) layer, and then output. The client signal D1 input to the network equipment A and output from the network equipment C is mapped into the payload of the OTUk signal in the high-level (upper) layer, and then transmitted. Therefore, the OH information in the client signal D1 is transparently transmitted without being terminated.

As illustrated in FIG. 2, in the transmission system 300, a multiplex (OTUk) layer on the side of a client signal input to network equipment A and a multiplex (OTUk) layer on the side of a transmission line (between the pieces of network equipment A, B, and C) are substantially identical with each other, and, for example, an OTU4 is used on both of the client signal side and the transmission line side. In this case, in the standard, OTUk OH information is terminated on the input side, and the values are rewritten on the output side.

For example, a transmission device 310A of the network equipment A terminates and rewrites the OTUk OH information of the client signal D1, and transmits the OTUk OH information to a transmission device 310B of the network equipment B. The transmission device 310B terminates and rewrites the OTUk OH information transmitted from the transmission device 310A, and transmits the OTUk OH information to a transmission device 310C of the network equipment C. The transmission device 310C terminates and rewrites the OTUk OH information transmitted from the transmission device 310B, and outputs the OTUk OH information. The OH information in the client signal D1 input to the network equipment A and output from the network equipment C is rewritten to different values, and therefore may not be transmitted transparently.

Constitutions having substantially the same or similar functions may be identified by the same reference symbols, and repeated description thereof may be omitted or reduced.

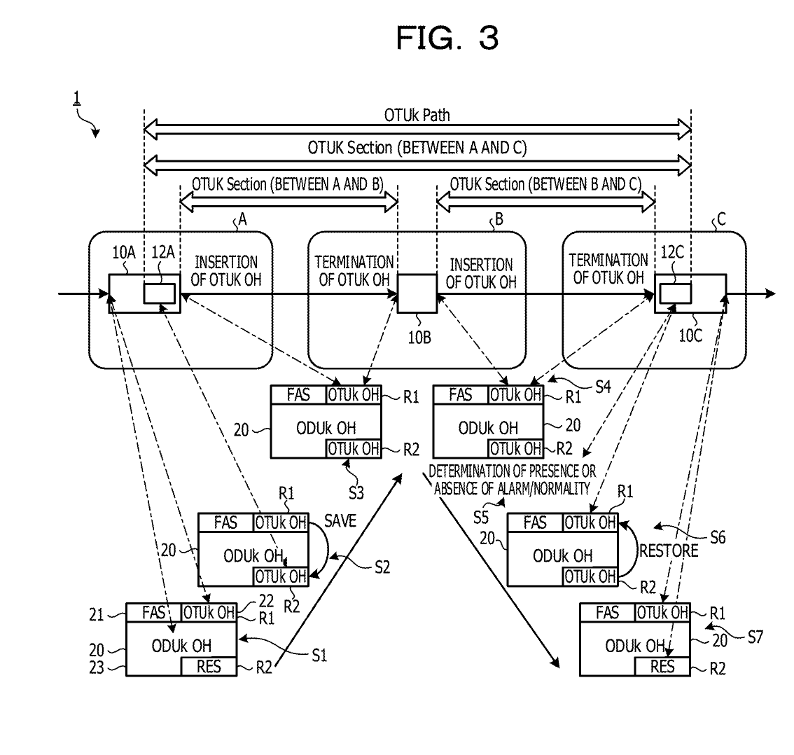

FIG. 3 illustrates an example of a transmission system. In a transmission system 1 of FIG. 3, a client signal may be input from network equipment A, passed through network equipment B, and then output from network equipment C. A similar description may be applied to a client signal in an opposite direction from that of FIG. 3.

As illustrated in FIG. 3, in the transmission system 1, a multiplex (OTUk) layer on the side of the client signal input to the network equipment A and a multiplex (OTUk) layer on the side of a transmission line (between the pieces of network equipment A, B, and C) may be substantially identical with each other. For example, an OTU4 may be used on both of the client signal side and the transmission line side. OTUk OH information is terminated in an OTUk section (between A and B) and an OTUk section (between B and C) in an ODUk path between the pieces of network equipment A and C.

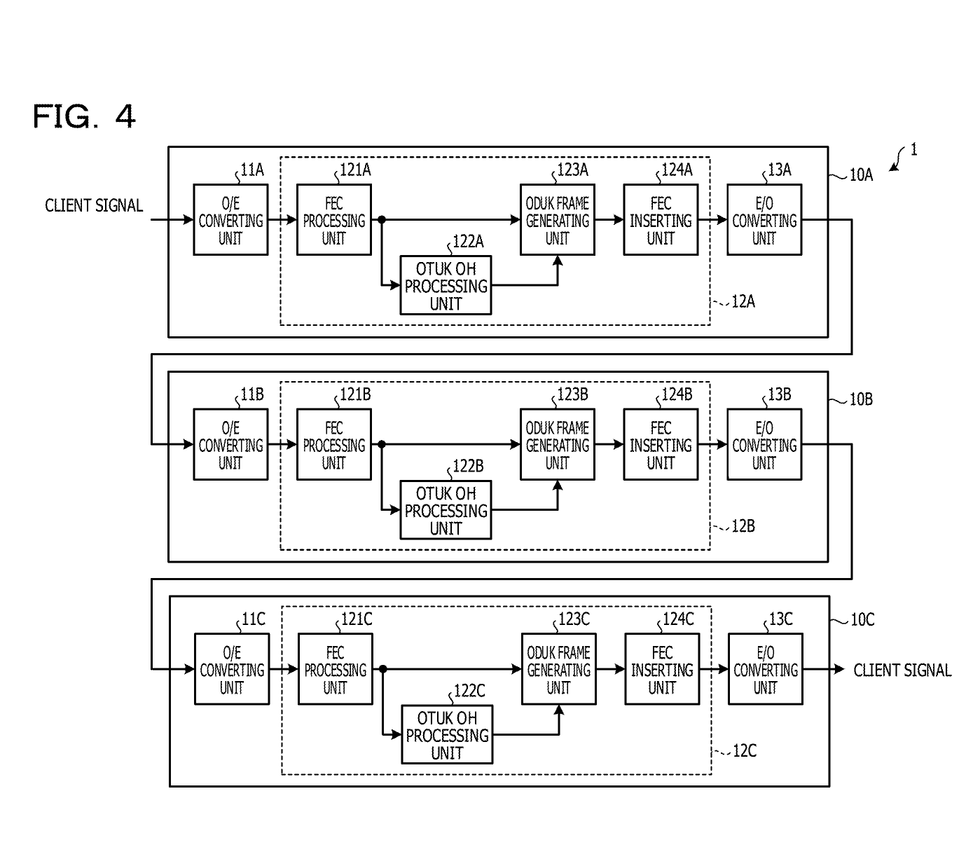

Transmission devices 10A, 10B, and 10C that transmit the client signal by an OTN transmission system are provided to the pieces of network equipment A, B, and C, respectively. FIG. 4 illustrates an example of hardware configuration of a transmission system. The transmission system illustrated in FIG. 4 may be the transmission system 1 illustrated in FIG. 3.

As illustrated in FIG. 4, the transmission device 10A includes an optical/electricity (O/E) converting unit 11A, a frame processing unit 12A, and an electricity/optical (E/O) converting unit 13A. The frame processing unit 12A includes a forward error correction (FEC) processing unit 121A, an OTUk OH processing unit 122A, an ODUk frame generating unit 123A, and an FEC inserting unit 124A.

Similarly, the transmission device 10B includes an O/E converting unit 11B, a frame processing unit 12B, and an E/O converting unit 13B. The frame processing unit 12B includes an FEC processing unit 121B, an OTUk OH processing unit 122B, an ODUk frame generating unit 123B, and an FEC inserting unit 124B. Similarly, the transmission device 10C includes an O/E converting unit 11C, a frame processing unit 12C, and an E/O converting unit 13C. The frame processing unit 12C includes an FEC processing unit 121C, an OTUk OH processing unit 122C, an ODUk frame generating unit 123C, and an FEC inserting unit 124C. For convenience, the configuration and functions of the transmission device 10A will be described in the following. However, the configuration and functions of the other transmission devices may be substantially the same or similar.

The O/E converting unit 11A converts the client signal, for example, an optical signal into an electric signal, and then outputs the electric signal after the conversion to the frame processing unit 12A. The frame processing unit 12A subjects an OTN frame included in the electric signal to given frame processing, and outputs the electric signal after the processing to the E/O converting unit 13A. The E/O converting unit 13A converts the electric signal processed by the frame processing unit 12A into an optical signal, and then transmits the optical signal. The optical signal converted by the E/O converting unit 13A is transmitted to the transmission device 10B via the OTUk section (between A and B).

The FEC processing unit 121A subjects payload data of the OTN frame to error correction code processing, and then outputs the frame after the processing to the OTUk OH processing unit 122A and the ODUk frame generating unit 123A. The OTUk OH processing unit 122A stores various kinds of operation information in an OTUk overhead region within the frame to be processed by the ODUk frame generating unit 123A. The ODUk frame generating unit 123A subjects the frame (ODUk frame) to given processing. The FEC inserting unit 124A inserts an FEC code into the frame generated by the ODUk frame generating unit 123A, and then outputs the frame to the E/O converting unit 13A.

The frame processing unit 12A saves overhead information (OTUk OH information) that is included in the input signal and is an object of termination in the ODUk path, to a given unused region within the frame based on a user setting. For example, when a setting for saving the OTUk OH information is made by a user, the OTUk OH processing unit 122A saves the OTUk OH information of the input client signal to the given unused region within the frame to be processed by the ODUk frame generating unit 123A.

The frame processing unit 12A writes back and restores the overhead information (OTUk OH information) included in the input signal and saved to the unused region of the frame to the original position within the frame based on a user setting. For example, when a setting for restoring the OTUk OH information is made by the user, the OTUk OH processing unit 122A writes back and restores, to the original OH region, the OTUk OH information saved to the unused region within the frame to be processed by the ODUk frame generating unit 123A.

The user setting for saving or restoring the OTUk OH information may be made by console operation on the transmission device itself, or may be made via an external device such as a network monitoring device that monitors the pieces of network equipment A, B, and C or the like. For example, the transmission device 10A of the network equipment A may be set to save the OTUk OH information, and the transmission device 10C of the network equipment C may be set to restore the OTUk OH information.

As illustrated in FIG. 3, a client signal is input to the transmission device 10A (S1). OH information 20 of the client signal includes a frame alignment signal (FAS) 21, OTUk OH information 22, and ODUk OH information 23. The transmission device 10A is set to save the OTUk OH information 22 as an object of termination. Therefore, the frame processing unit 12A of the transmission device 10A saves the OTUk OH information 22 stored in a region R1 to a region R2 storing an unused RES (Reserved Byte) in the ODUk OH information 23 within the frame (S2). The frame in which the OTUk OH information 22 included in the client signal is saved to the unused region R2 is thus transmitted in the ODUk path.

In the OTUk section (between A and B), the OTUk OH information in the region R1 is overwritten and terminated (S3). In the OTUk section (between B and C), the OTUk OH information in the region R1 is overwritten and terminated (S4).

The transmission device 10C is set to restore the OTUk OH information 22 as an object of termination. Therefore, the frame processing unit 12C of the transmission device 10C checks for the presence or absence of a transmission line alarm and/or the normality of the OTUk OH information 22 saved in the unused region R2 within the frame (S5). When there is no transmission line alarm, and the normality of the OTUk OH information 22 is confirmed, the frame processing unit 12C writes back and restores, to the original region R1, the OTUk OH information 22 saved in the unused region R2 within the frame (S6). The OTUk OH information 22 of the client signal input to the transmission device 10A is restored, and then output from the transmission device 10C (S7).

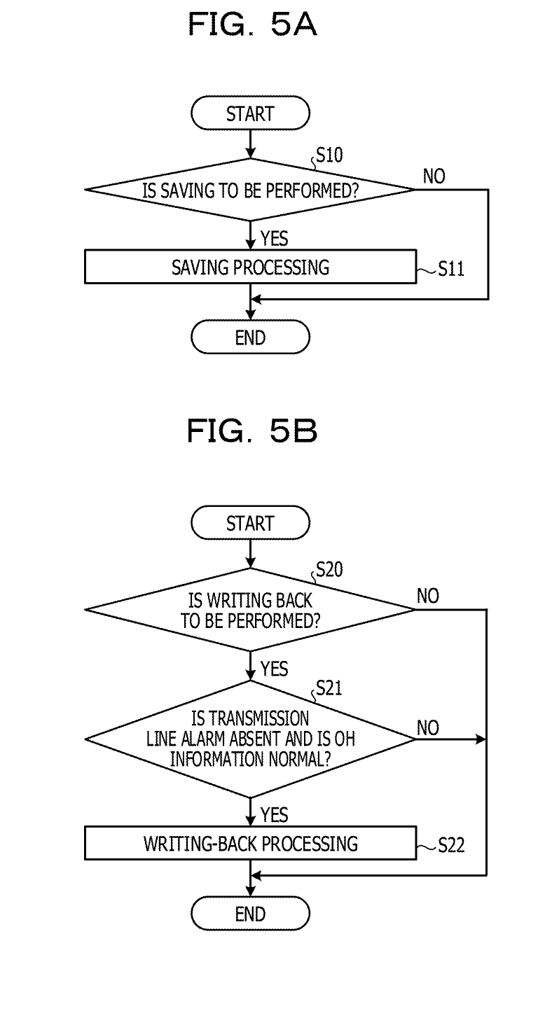

FIG. 5A illustrates an example of processing on a transmitting side. FIG. 5B illustrates an example of processing on a receiving side.

As illustrated in FIG. 5A, the frame processing units 12A, 12B, and 12C determine whether or not to save the OTUk OH information 22 based on a user setting (S10). The transmission device 10A is set to save the OTUk OH information 22. Thus, the frame processing unit 12A determines that the frame processing unit 12A is to perform saving (S10: YES). The frame processing units 12B and 12C are not set to save the OTUk OH information 22. Thus, the frame processing units 12B and 12C determine that the frame processing units 12B and 12C are not to perform saving (S10: NO).

Because the frame processing unit 12A is to perform saving, the frame processing unit 12A performs saving processing that saves the OTUk OH information 22 stored in the region R1 to the unused region R2 within the frame (S11).

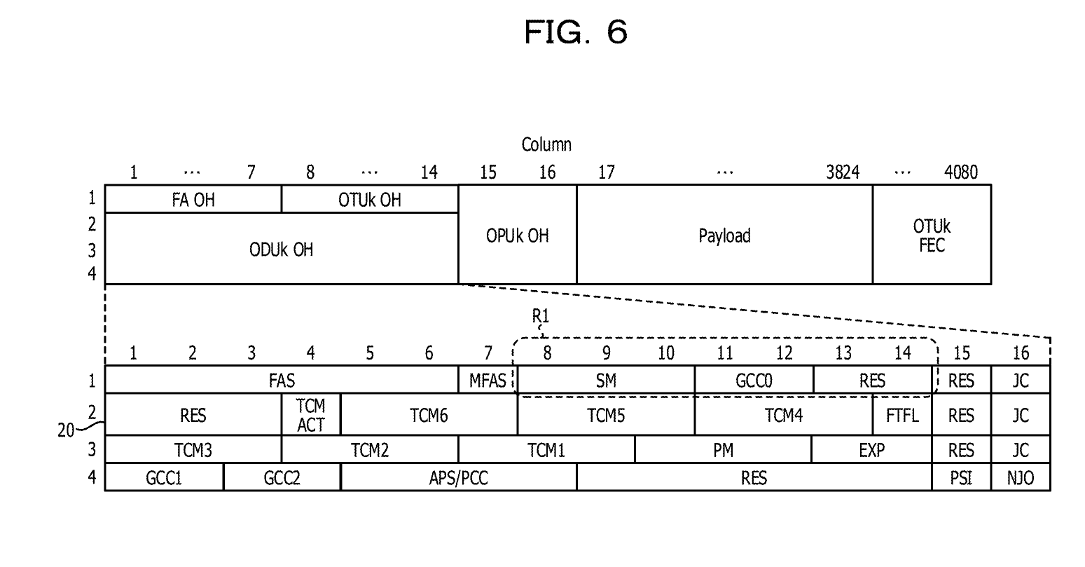

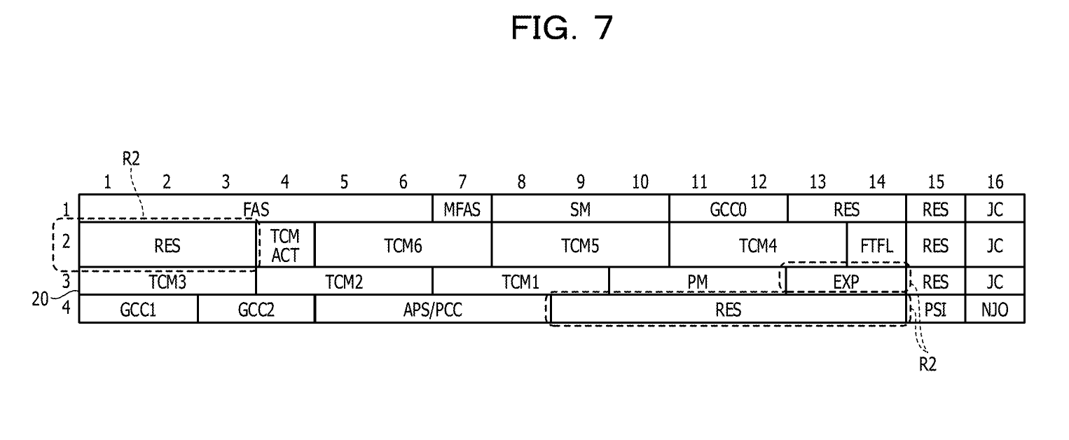

FIG. 6 and FIG. 7 illustrate an example of overhead information. FIG. 6 illustrates the position of the region R1. FIG. 7 illustrates the position of the region R2. As illustrated in FIG. 6, information such as a section monitoring (SM), a general communication channel 0 (GCC0), and an RES or the like stored in the region R1 is saved. Information to be saved among the SM, the GCC0, and the RES may be arbitrarily selected by a user setting, for example.

As illustrated in FIG. 7, the unused region R2 in the OH information 20 includes an RES (row 2, 3 bytes), an EXP (row 3, 2 bytes), and an RES (row 4, 6 bytes), or the like. A region as a saving destination in the region R2 may be a single region or an arbitrary combination of a plurality of regions based on a user setting.

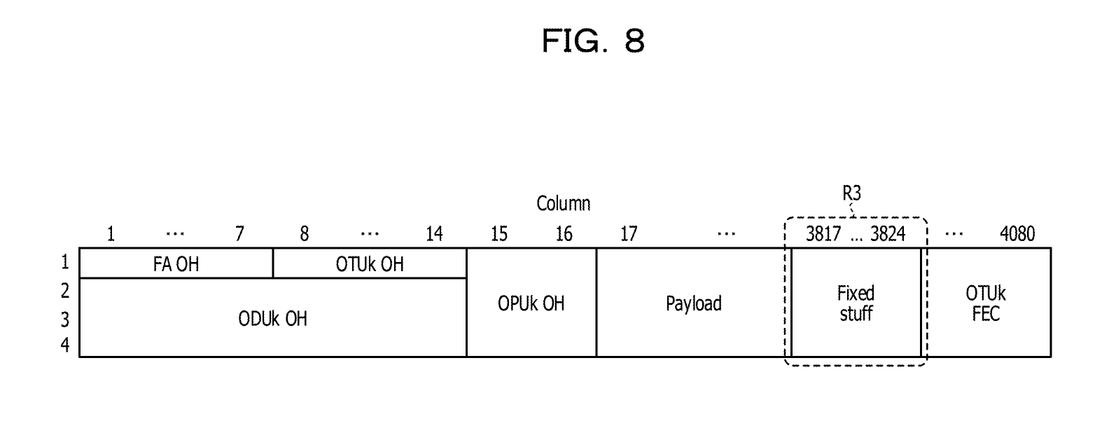

The region as a saving destination in the OTUk OH information 22 is not limited to a region within the OH information 20, but may be within a payload as long as the region is an unused region within the frame. FIG. 8 illustrates an example of an OTU4 frame. As illustrated in FIG. 8, the OTUk OH information 22 may be saved to arbitrary bytes in a region R3 of Fixed stuff bytes (columns 3817 to 3824, 32 bytes) within the payload.

The region as a saving destination in the OTUk OH information 22 may not be only within the identical frame that includes the OTUk OH information 22, but may be an unused region in one of a previous frame and a subsequent frame based on a user setting.

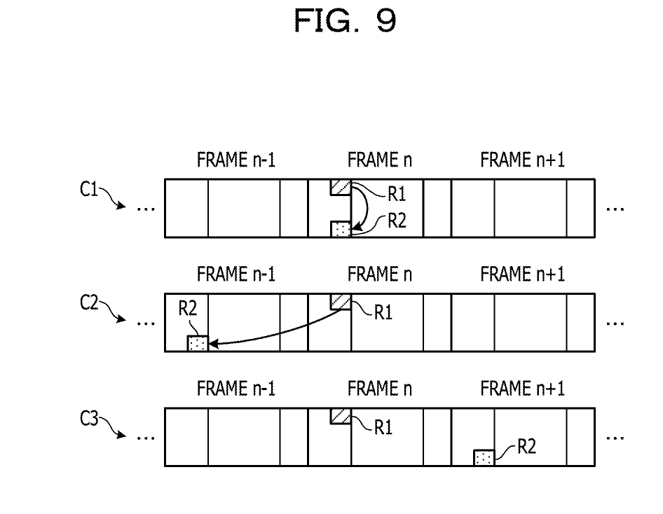

FIG. 9 illustrates an example of frames as saving destinations. As illustrated in a case C1 of FIG. 9, the frame processing unit 12A may save the OTUk OH information 22 stored in the region R1 of a frame (n) to the region R2 of the identical frame. As illustrated in a case C2, the frame processing unit 12A may save the OTUk OH information 22 stored in the region R1 of the frame (n) to the region R2 of a previous frame (n−1). As illustrated in a case C3, the frame processing unit 12A may save the OTUk OH information 22 stored in the region R1 of the frame (n) to the region R2 of a subsequent frame (n+1).

In saving and restoring the OTUk OH information 22 to and from the unused region of one of the previous frame and the subsequent frame, data for restoration, for example, frame information, and/or the OTUk OH information 22 to be saved and restored are/is temporarily stored in a memory. The temporarily stored data may be processed in accordance with frames processed sequentially.

As illustrated in FIG. 5B, the frame processing units 12A, 12B, and 12C determine whether or not to write back the OTUk OH information 22 saved to the region R2 or R3 based on a user setting (S20). The transmission device 10C is set to restore the OTUk OH information 22, for example, and therefore the frame processing unit 12C determines that the frame processing unit 12C is to perform writing back (S20: YES). The frame processing units 12A and 12B are not set to restore the OTUk OH information 22, and therefore determine that the frame processing units 12A and 12B are not to perform writing back (S20: NO). When writing back is not to be performed, the processing is ended.

Because the frame processing unit 12C is to perform writing back, the frame processing unit 12C determines whether or not a transmission line alarm is absent and whether or not the OTUk OH information 22 is normal (S21). For example, the frame processing unit 12C determines whether or not the input signal includes signal disappearance (loss of signal)/frame synchronization loss (loss of frame) information (LOS/LOF information), a transmission line alarm such as an alarm indication signal (AIS) alarm or the like. The frame processing unit 12C may determine the normality of the saved OTUk OH information 22 by checking the saved OTUk OH information 22. For example, in the SM in the OTUk OH information 22, the normality may be determined based on source access point identifier/destination access point identifier information (SAPI/DAPI information) and/or bit interleaved parity (BIP) 8 information.

When the transmission line alarm is absent, and the normality of the OTUk OH information 22 is confirmed (S21: YES), the frame processing unit 12C performs writing-back processing that writes back and restores the OTUk OH information 22 saved in the unused region R2 or R3 within the frame to the original region R1 (S22).

The writing-back processing is performed after it is confirmed that there is no transmission line alarm and the normality of the OTUk OH information 22 is confirmed. Therefore, even when the saved OTUk OH information 22 is lost due to an abnormality in the ODUk path, the restoration using wrong information, for example, the fixed pattern of the AIS signal may be reduced.

In the above-described writing-back processing, based on a user setting, the frame processing unit 12C reads the OTUk OH information 22 saved to the arbitrarily selected region R2 or R3, and restores the OTUk OH information 22 to the original region R1. Also in the case where the OTUk OH information 22 is saved to the unused region of one of the previous frame and the subsequent frame, the frame processing unit 12C similarly restores the OTUk OH information 22 by temporarily storing appropriate data in a memory in advance and processing the temporarily stored data in accordance with frames processed sequentially.

In the transmission system 1, the transmission device 10A saves the OTUk OH information 22, which is included in a frame of the client signal and is an object of termination in the ODUk path, to the unused region R2 within the frame, and transmits an optical signal including the frame in which the OTUk OH information 22 is saved to the unused region R2. After the transmission device 10C restores the saved OTUk OH information 22 by writing back the OTUk OH information 22 saved to the region R2 in the frame included in the received optical signal to the original position, the transmission device 10C outputs the signal including the restored frame. Therefore, in the transmission system 1, the OTUk OH information 22 of the input signal is transmitted transparently in the transmission section in which the OTUk OH information 22 is terminated.

Transparently transmitting the OTUk OH information 22 in the section from the network equipment A to the network equipment C, for example, the sections of the network equipment B provides a great advantage also in network management.

For example, when the service area of the transmission system 1 becomes larger, realizing service in the entire area with only the network equipment of one communication carrier may result in poor cost effectiveness. As a measure, operation may be performed in which the network equipment of another communication carrier is rented. However, in the case of the operation in which the network equipment of another communication carrier is rented, the monitoring of the entire network may be affected.

For example, when the network equipment B illustrated in FIG. 3 is equipment rented from another communication carrier, the monitoring of the sections of the network equipment B may be difficult due to differences in specifications related to network management or the like. For example, when the OTUk OH information 22 is transmitted transparently in the sections of the network equipment B, the sections of the network equipment B may be treated as equivalent to a simple light transmission line. The network management may therefore be performed without awareness of the sections of the network equipment B.

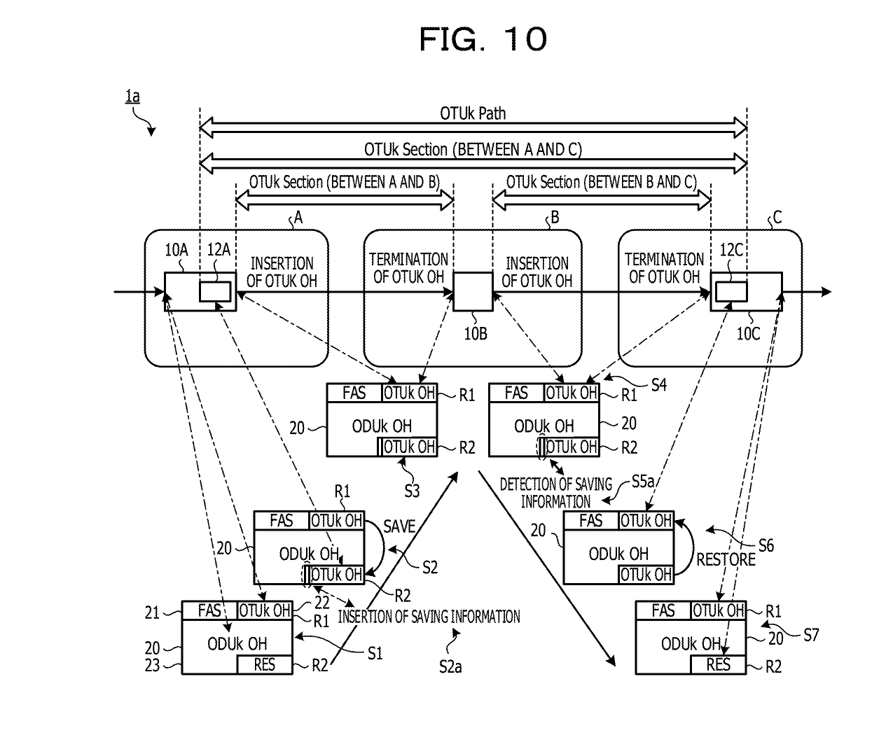

FIG. 10 illustrates an example of a transmission system. As illustrated in FIG. 10, in a transmission system 1a, when a frame processing unit 12A of a transmission device 10A saves OTUk OH information 22, the frame processing unit 12A inserts (stores), into a region R2, saving information indicating that the OTUk OH information 22 is saved (S2a). A frame processing unit 12C of a transmission device 10C detects the saving information stored in the region R2 (S5a). When the saving information is stored, the frame processing unit 12C writes back the OTUk OH information 22 saved to the region R2.

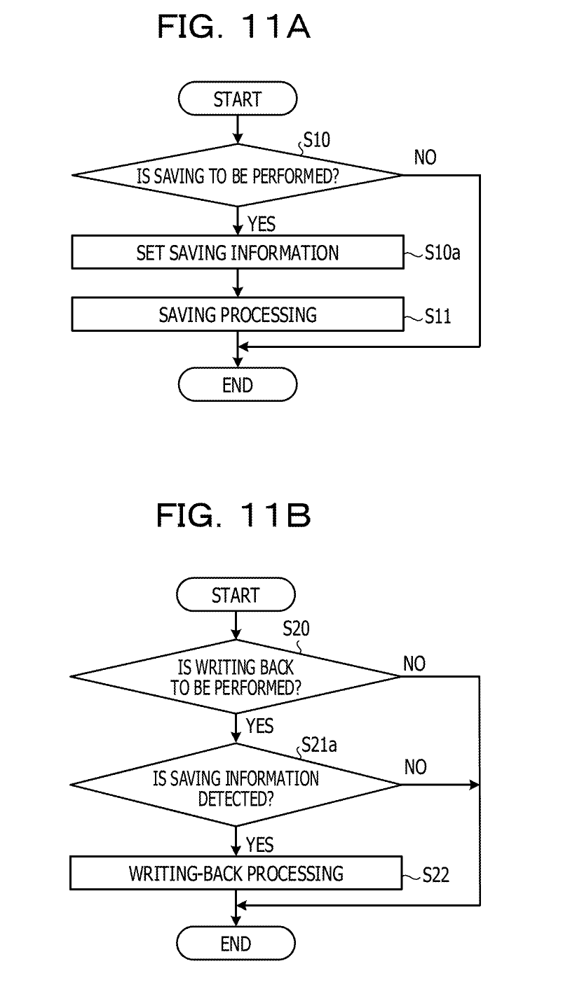

FIG. 11A illustrates an example of processing on a transmitting side. The processing illustrated in FIG. 11A may be performed in the transmission system la illustrated in FIG. 10.

As illustrated in FIG. 11A, frame processing units 12A, 12B, and 12C determine whether or not to save the OTUk OH information 22 based on a user setting (S10). The transmission device 10A is set to save the OTUk OH information 22, for example. Thus, the frame processing unit 12A determines that the frame processing unit 12A is to perform saving (S10: YES). The frame processing units 12B and 12C are not set to save the OTUk OH information 22. The frame processing units 12B and 12C therefore determine that the frame processing units 12B and 12C are not to perform saving (S10: NO).

The frame processing unit 12A is to perform saving. The frame processing unit 12A therefore performs saving processing that sets (stores) saving information indicating saving in the unused region R2 within the frame (S10a) and that saves the OTUk OH information 22 in the region R2 (S11).

As illustrated in FIG. 11B, the frame processing units 12A, 12B, and 12C determine whether or not to write back the OTUk OH information 22 saved to the region R2 or a region R3 based on a user setting (S20). The transmission device 10C is set to restore the OTUk OH information 22, for example. Thus, the frame processing unit 12C determines that the frame processing unit 12C is to perform writing back (S20: YES). The frame processing units 12A and 12B are not set to restore the OTUk OH information 22. The frame processing units 12A and 12B therefore determine that the frame processing units 12A and 12B are not to perform writing back (S20: NO). When writing back is not to be performed, the processing is ended.

The frame processing unit 12C is to perform writing back. Thus, the frame processing unit 12C refers to the region R2, and determines whether or not the saving information is detected (S21a). When the saving information is not detected (S21a: NO), the OTUk OH information 22 is not saved in the region R2, and therefore the frame processing unit 12C ends the processing without performing the writing-back processing. When the saving information is detected (S21a: YES), the OTUk OH information 22 is saved to the region R2, and therefore the frame processing unit 12C performs the writing-back processing (S22).

When whether or not to perform the writing-back processing is determined based on a transmission line alarm and the like, a plurality of alarms may be integrated. When the saving information is used, for example, only the monitoring of the region R2 is performed, so that a processing configuration may be simplified. In a case where normality is determined based on SAPI/DAPI information in an SM and the writing-back processing is performed, the SAPI/DAPI information is transferred in multiple frames. Therefore the determination may be made after reception of a plurality of frames. When the saving information is used, for example, only the monitoring of the region R2 within one frame is performed, so that an instant determination may be made. Even when the monitoring of the region R2 is performed, another method such as the transmission line alarm and the like may be used for the determination, for example.

When normality is determined based on BIP8 information in the SM, and the writing-back processing is performed, an instant determination may be made because the BIP8 information is information that precedes by two frames. For example, error information of the BIP8 information does not include the OH region. Thus, when saving is performed to an OH region, the determination of exact normality may be difficult. When the saving information is used, the saving information is stored in the same region as the saved OTUk OH information 22. Therefore a more accurate determination may be made.

When normality is determined based on GCC0 information, and the writing-back processing is performed, there is a possibility of the GCC0 information being a random signal, so that the determination of normality may be difficult. In the case where the saving information is used, for example, even when a signal in a format that makes the determination of normality difficult such as the GCC0 information or the like is saved, the determination of normality may be made.

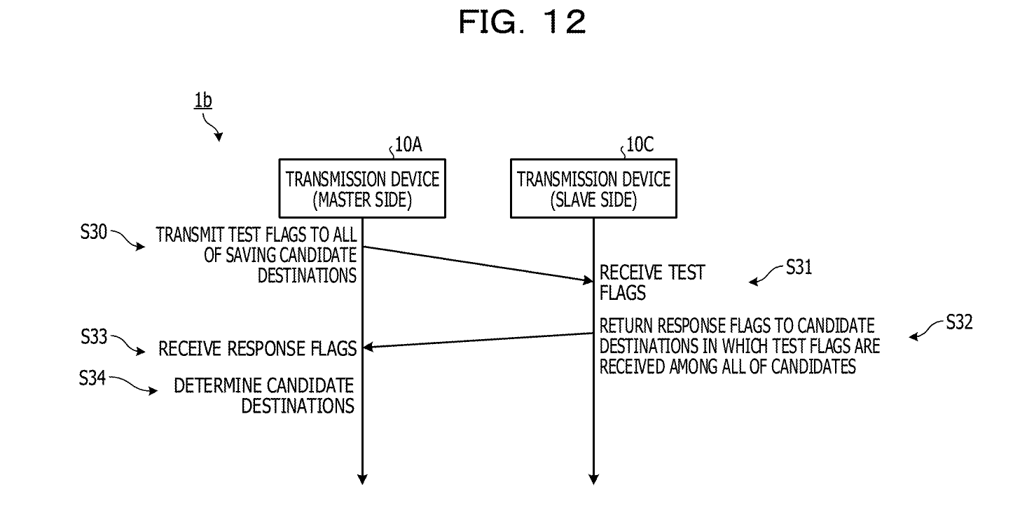

FIG. 12 illustrates an example of processing of a transmission system. FIG. 12 represents a ladder chart of operation of a transmission system 1b. A configuration of the transmission system 1b may be substantially the same as or similar to those of the transmission systems 1 and 1a, and therefore description thereof may be omitted and reduced.

As illustrated in FIG. 12, in the transmission system 1b, a master side that saves OTUk OH information 22 and transmits the OTUk OH information 22 (transmission device 10A) makes a test transmission for all of unused regions R2 within a frame to a slave side that restores the OTUk OH information 22 (transmission device 10C). The transmission device 10A determines a region R2 in which there is a response to the test transmission from the transmission device 10C as a candidate destination to which the OTUk OH information 22 is saved.

For example, the transmission device 10A adds a given test flag to all of unused regions R2 (all of saving candidate destinations) within a frame, and makes a transmission (S30).

When a usually unused region R2 is used between the transmission devices 10A and 10C, the added test flag is rewritten into other data. Therefore, when the transmission device 10C confirms the given test flag, it may be confirmed that the region R2 is unused between the transmission devices 10A and 10C.

The transmission device 10C receives the frame in which the test flags are added (S31), adds a response flag to the regions R2 as candidate destinations in which the given test flags are received, and then returns the frame (S32).

The transmission device 10A receives the frame in which the response flags are added (S33), and determines the regions R2 to which the response flags are added as candidate destinations to which the OTUk OH information 22 is saved (S34). Therefore, in the transmission system 1b, the OTUk OH information 22 is saved to the regions R2 not used between the transmission devices 10A and 10C, for example, by the network equipment B.

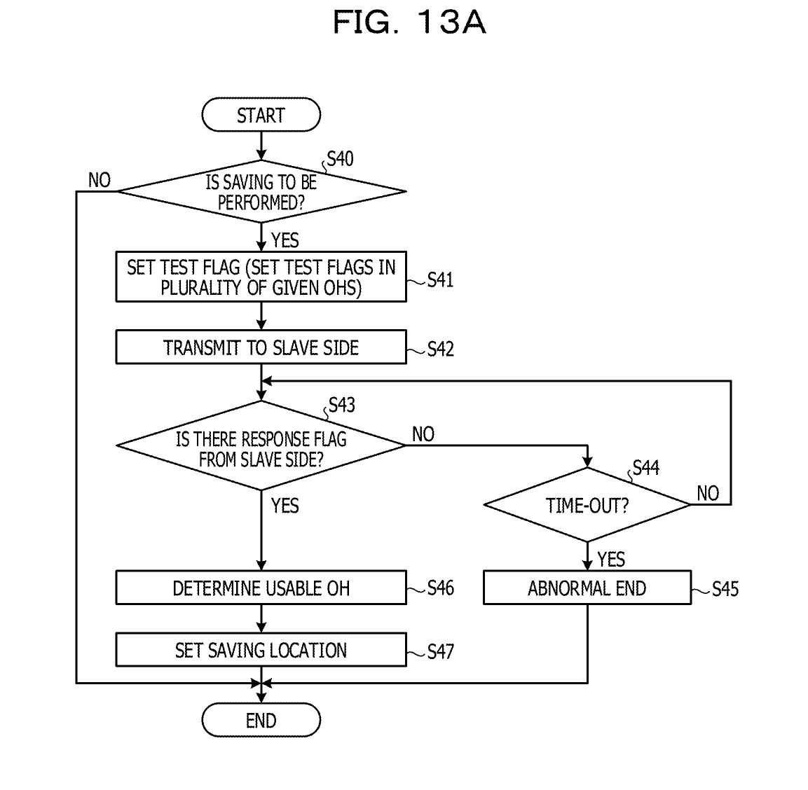

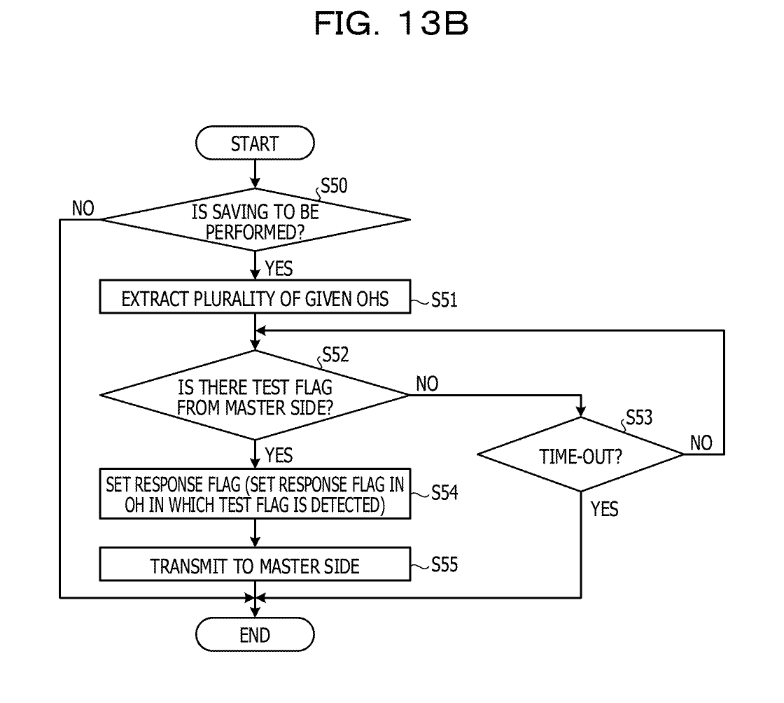

FIG. 13A illustrates an example of processing on a master (transmitting) side. As illustrated in FIG. 13A, the frame processing unit 12A determines whether or not to save the OTUk OH information 22 based on a user setting (S40). When the frame processing unit 12A is not to perform saving (S40: NO), the frame processing unit 12A ends the processing.

When the frame processing unit 12A is to perform saving (S40: YES), the frame processing unit 12A sets a given test flag in a plurality of regions R2 unused within a frame (S41). An RES (row 2, 3 bytes), an EXP (row 3, 2 bytes), an RES (row 4, 6 bytes), Fixed stuff bytes within a payload, and the like may be used as the regions R2 in which the test flags are set.

The frame processing unit 12A transmits the frame in which the test flags are set to the slave side via an E/O converting unit 13A (S42). The frame processing unit 12A determines whether or not there is a response flag from the slave side (S43). When there is no response flag from the slave side (S43: NO), the frame processing unit 12A determines whether or not a time-out has occurred (S44). When the time-out has not occurred (S44: NO), the frame processing unit 12A sets the processing in a waiting state. When the time-out has occurred (S44: YES), the frame processing unit 12A makes an abnormal end because there is no region R2 as a candidate for a saving destination and thus saving is difficult (S45). In the case of the abnormal end, the user may be notified by outputting an alert, for example, that it is difficult to save the OTUk OH information 22.

When there is a response flag from the slave side (S43: YES), the frame processing unit 12A determines whether or not there is OTUk OH information 22 that can be used in (that can be saved to) the region R2 to which the response flag is added (S46). For example, when various kinds of information of the OTUk OH information 22 can be stored in the region R2 to which the response flag is added, it may be determined that the information can be saved. The frame processing unit 12A sets a saving location of the OTUk OH information 22, which is determined to be able to be saved, in the region R2 to which the response flag is added (S47).

FIG. 13B illustrates an example of processing on the slave (receiving) side. As illustrated in FIG. 13B, the frame processing unit 12C determines whether or not to save the OTUk OH information 22 based on a user setting (S50). When the frame processing unit 12C is not to perform saving (S50: NO), the frame processing unit 12C ends the processing.

When the frame processing unit 12C is to perform saving (S50: YES), the frame processing unit 12C extracts information from the plurality of regions R2 unused within the frame (S51), and determines whether or not there is a test flag from the master side (S52). When there is no test flag (S52: NO), the frame processing unit 12C determines whether or not a time-out has occurred (S53). When the time-out has not occurred (S53: NO), the frame processing unit 12C sets the processing in a waiting state. When the time-out has occurred (S53: YES), the frame processing unit 12C ends the processing.

When there is a test flag (S52: YES), the frame processing unit 12C sets a response flag in the region R2 in which the test flag is detected (S54), and transmits the frame in which the response flag is set to the master side via an E/O converting unit 13C in an opposite direction from FIG. 4 (S55).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission system comprising:
a first transmission device configured to transmit an input signal to a second transmission device via a transmission section
the first transmission device preforms operations of:
saving overhead information included in a first frame of the input signal from a region in use to an unused region of the first frame, the overhead information corresponding to an object of termination in the transmission section; and
transmitting, to the transmission section, a first signal including a second frame in which the overhead information is saved.

2. The transmission system according to claim 1,
wherein the second transmission device
receives the first signal,
restores the saved overhead information by writing back the overhead information saved to the unused region of the second frame to the region in use, and
outputs a second signal including a third frame in which the saved overhead information is restored.

3. The transmission system according to claim 2,
wherein the second transmission device restores the saved overhead information in one of cases where the second signal does not include a transmission alarm and where the saved overhead information is normal.

4. The transmission system according to claim 1,
wherein when the first transmission device saves the overhead information, the first transmission device stores saving information indicating the saving in the unused region, and
wherein when the saving information is stored in the unused region of the second frame, the second transmission device writes back the overhead information saved to the unused region.

5. The transmission system according to claim 1,
wherein the first transmission device saves the overhead information to the unused region of a fourth frame which is one of the preceding and the succeeding of the first frame, and
wherein the second transmission device writes back the overhead information saved to the unused region of the fourth frame to an original position in the first frame.

6. The transmission system according to claim 1,
wherein the first transmission device
sets a given value to each of a plurality of unused regions of a fifth frame of the input signal, and transmits the third signal including the fifth frame to the second transmission device via the transmission section, and
determines the unused region to which the overhead information is saved based on a response to the fifth frame from the second transmission device.

7. The transmission system according to claim 6,
wherein the second transmission device sets a response flag at least one of the plurality of unused regions of the fifth frame, and transmits the fifth frame to the first transmission device.

8. A transmission device comprising:
a device preforms operations to:
receive, via a transmission section, a first signal including a second frame in which overhead information of a first frame of an input signal input to another transmission device is saved from a region in use to an unused region, the overhead information corresponding to an object of termination in the transmission section;
restore the saved overhead information by writing back the overhead information saved to the unused region in the second frame to the region in use; and
output a second signal including a third frame in which the overhead information is restored.

9. The transmission device according to claim 8, wherein the device restores the saved overhead information in one of cases where the first signal does not include a transmission alarm and where the saved overhead information is normal.

10. The transmission device according to claim 8,
wherein, when saving information indicating the saving is stored in the unused region of the second frame, the device writes back the overhead information saved to the unused region.

11. The transmission device according to claim 8,
wherein the device receives, from the another transmission device, a third signal including a fourth frame which is one of the preceding and the succeeding of the first frame and includes the unused region in which the overhead information is saved, and writes back the overhead information saved to the unused region of the fourth frame to an original position in the first frame.

12. The transmission device according to claim 8,
wherein the device receives a fourth signal including a fifth frame including a plurality of unused regions each set to a given value from the another transmission device via the transmission section,
sets a response flag at least one of the plurality of unused regions of the fifth frame, and
transmits a fifth signal including a sixth frame in which the response flag is set to the another transmission device.

13. A transmission method comprising:
receiving an input signal;
saving overhead information included in a first frame of the input signal from a region in use to an unused region of the first frame, the overhead information corresponding to an object of termination in a transmission section between a first transmission device and a second transmission device; and
transmitting, to the transmission section, a first signal including a second frame in which the overhead information is saved.

14. The transmission method according to claim 13, further comprising:
receiving the first signal in the second transmission device;
restoring the overhead information by writing back the overhead information saved to the unused region of the second frame to the region in use; and
outputting a second signal including a third frame in which the overhead information is restored.
